(19) United States
(12) Patent Application Publication
(10) Pub. No.: US 2026/0285264 A1
(43) Pub. Date: Sep. 24, 2026

(54) VEHICLE CONTROL APPARATUS

(71) Applicants: DENSO CORPORATION, Kariya-city (JP); TOYOTA JIDOSHA KABUSHIKI KAISHA, Toyota-shi (JP); J-QuAD DYNAMICS Inc., Tokyo (JP)

(72) Inventors: Yusuke IZUMI, Tokyo (JP); Satoshi KOJIMA, Sunto-gun, Shizuoka-ken (JP)

(21) Appl. No.: 19/567,737

(22) Filed: Mar. 16, 2026

(30) Foreign Application Priority Data
Mar. 18, 2025 (JP) 2025-043161

(51) Int. Cl. B60T 7/22; G01S 13/86; G01S 13/931; G06T 7/13; G06T 7/246; G06T 7/73; G06V 20/58

(52) U.S. Cl. CPC B60T 7/22; G01S 13/867; G01S 13/931; G06T 7/13; G06T 7/246; G06T 7/73; G06V 20/58; B60T 2210/32; B60T 2250/04; B60T 2270/89; G01S 2013/93185; G06T 2207/20164; G06T 2207/30241; G06T 2207/30261; G06V 2201/08

(57) ABSTRACT

A vehicle control apparatus is provided with an object recognition unit, a trajectory estimation unit, a selected-object determination unit and a braking control unit that executes a second braking control including suppressing actuation of the brake when a low-overlap condition is satisfied. The second braking control is configured to: i) determine an avoidance space where the vehicle is capable traveling adjacently to the selected object, thereby determining a transition of the avoidance space along the trajectory of the selected object, ii) determine whether another object exists in the avoidance space, iii) actuate the brake when a braking condition including that another object exists in the avoidance space is satisfied and iv) suppress actuation of the brake when an avoidance condition including that other object does not exist in the avoidance space is satisfied.

### CROSS-REFERENCE TO RELATED APPLICATION

This application is based on and claims the benefit of priority from earlier Japanese Patent Application No. 2025-043161 filed Mar. 18, 2025, the description of which is incorporated herein by reference.

### BACKGROUND

### Technical Field

The present disclosure relates to a vehicle control apparatus.

### Description of the Related Art

There are various techniques for predicting collisions between vehicles. According to known techniques, the estimated trajectory of the own vehicle and the estimated trajectory of an object are calculated, in a three-dimensional coordinate system defined by longitudinal position, lateral position, and time axis, as a solid representing the transition of the presence region of the own vehicle and a solid representing the transition of the presence region of the object. The object may be, for example, another vehicle detected by a radar device of the own vehicle. Further, the estimated trajectory of the own vehicle is calculated based on the current position, the vehicle speed, and the rate of change of the steering angle. The estimated trajectory of the object is calculated based on the current position and the relative velocity with respect to the own vehicle.

### SUMMARY

One aspect of the present disclosure is a vehicle control apparatus mounted on a vehicle provided with an object detection unit acquiring environmental information ahead of the vehicle. The vehicle control apparatus includes:
an object recognition unit that recognizes a plurality of objects ahead of the vehicle based on the environmental information, and calculates distances and relative speeds between respective objects and the vehicle;
a trajectory estimation unit that estimates a trajectory of the vehicle and trajectories of the plurality of objects;
a selected-object determination unit that determines a selected object selected from among target objects by calculating a predicted collision time between the vehicle and each target object, the target objects being determined to possibly collide with the vehicle based on the trajectory of the vehicle and the trajectories of the plurality of objects, the selected object having the shortest predicted collision time among those in the target objects; and
a braking control unit that executes a first braking control to activate a brake of the vehicle when a high-overlap condition is satisfied and executes a second braking control including suppressing actuation of the brake when a low-overlap condition is satisfied, the high-overlap condition being that an amount of overlapping between the vehicle and the selected object in a width direction, with respect to the trajectory of the vehicle and trajectories of the plurality of objects, is within a first range, and the low-overlap condition being that an amount of overlapping between the vehicle and the selected object in a width direction, with respect to the trajectory of the vehicle and trajectories of the plurality of objects, is within a second range smaller than the first range,
   wherein
the second braking control is configured to: i) determine an avoidance space where the vehicle is capable traveling adjacently to the selected object, thereby determining a transition of the avoidance space along the trajectory of the selected object, ii) determine whether another object exists in the avoidance space based on a trajectory of another object other than the selected object among trajectories of the plurality of objects and a result of transition of the avoidance space and iii) actuate the brake when a braking condition including that another object exists in the avoidance space is satisfied and iv) suppress actuation of the brake when an avoidance condition including that another object does not exist in the avoidance space is satisfied.

### BRIEF DESCRIPTION OF THE DRAWINGS

In the accompanying drawings:

FIG. 1 is an explanatory diagram showing an overall configuration of a vehicle control system;

FIG. 2 is an explanatory diagram showing an example of traveling of an own vehicle and another vehicle;

FIG. 3 is a flowchart showing a control flow of a vehicle control device;

FIG. 4 is an explanatory diagram showing an avoidance space;

FIG. 5 is an explanatory diagram showing an example of another object present in the avoidance space;

FIG. 6 is a flowchart showing determination conditions for an available avoidance space;

FIG. 7 is an explanatory diagram showing an example of a determination result as to whether an available avoidance space exists; and

FIG. 8 is an explanatory diagram showing another example of a determination result as to whether an available avoidance space exists.

### DETAILED DESCRIPTION OF THE PREFERRED EMBODIMENTS

As a technique for predicting collisions between vehicles, techniques disclosed in patent literature, for example, JP-A-2020-8288 and JP-A-2017-114427 may be cited. According to the techniques disclosed in the above patent literature JP-A-2020-8288, the estimated trajectory of the own vehicle and the estimated trajectory of an object are calculated, in a three-dimensional coordinate system defined by longitudinal position, lateral position, and time axis, as a solid representing the transition of the presence region of the own vehicle and a solid representing the transition of the presence region of the object. The object may be, for example, another vehicle detected by a radar device of the own vehicle. Further, the estimated trajectory of the own vehicle is calculated based on the current position, the vehicle speed, and the rate of change of the steering angle. The estimated trajectory of the object is calculated based on the current position and the relative velocity with respect to the own vehicle.

The above-mentioned techniques determine whether a collision will occur by judging the presence or absence of an intersection between both solids and predicts a collision when an intersection exists. In this case, for example, the technique of the above-described JP-A-2020-8288 actuates the brakes.

As a technique for predicting collision between vehicles, the technique disclosed in JP-A-2017-114427 can also be cited. The technique of JP-A-2017-114427 predicts a vehicle collision based on a vehicle overlap ratio. The vehicle overlap ratio is an index indicating the amount of overlap in the vehicle width direction between the own vehicle and an object. The greater the vehicle overlap ratio, the higher the possibility of a collision is. Conversely, the smaller the vehicle overlap ratio, the higher the possibility that the driver can avoid the collision through driving operations. That is, the vehicle overlap ratio represents the likelihood that a collision can be avoided by the driver's operation.

The technique disclosed in JP-A-2017-114427 avoids a vehicle collision by automatically actuating the brakes when the predicted time to collision, which is based on the vehicle overlap ratio, becomes less than or equal to a threshold. When the vehicle overlap ratio is small, the driver is likely to avoid the collision through manual operation. The technique of JP-A-2017-114427 adjusts the threshold in order to suppress brake actuation in such situations. Specifically, when the vehicle overlap ratio is small, a threshold based on a steering-limit collision time is set. The steering-limit collision time is the limit time within which the driver can avoid the collision by operating the steering wheel. Thus, brake actuation is suppressed within a time period during which collision avoidance by the driver's operation is possible, thereby preventing interference between the driver's operation and automatic brake actuation. Consequently, the technique of JP-A-2017-114427 can suppress unnecessary brake actuation.

The inventors had developed a technique referring to the above-described patent literature. This technique enables braking to be activated at more appropriate timing by combining collision prediction using three-dimensional coordinates with an avoidance technique based on a vehicle overlap ratio as disclosed in the above-described patent literature. That is, even when an estimated trajectory of the own vehicle and an estimated trajectory of an object intersect in three-dimensional coordinates, automatic braking is suppressed in cases where a collision can be avoided by the driver's operation.

However, according to a collision prediction based on the intersection of estimated trajectory as disclosed in the above-described patent literature, the prediction may be delayed. For example, when the own vehicle avoids a collision with an object located ahead in the traveling direction, the own vehicle may steer to avoid the object and pass alongside it. In this case, with the technique of the above-described patent literature, a collision between the own vehicle and an obstacle in the avoidance direction cannot be predicted until the driver operates the steering wheel and the traveling path to the avoidance destination is determined. That is, when an obstacle exists at a lateral side of the object, the technique of the above-described patent literature may be unable to secure sufficient time to avoid the obstacle.

However, even when it is difficult to avoid an obstacle in the avoidance direction, the technique of the above-described patent literature may suppress the activation of automatic braking. As a result, a discrepancy may arise between the behavior of the own vehicle and the driver's judgment, potentially causing the driver to feel discomfort or unease.

Hereinafter, embodiments of the present disclosure will be described.

### First Embodiment

A system configuration will be described.

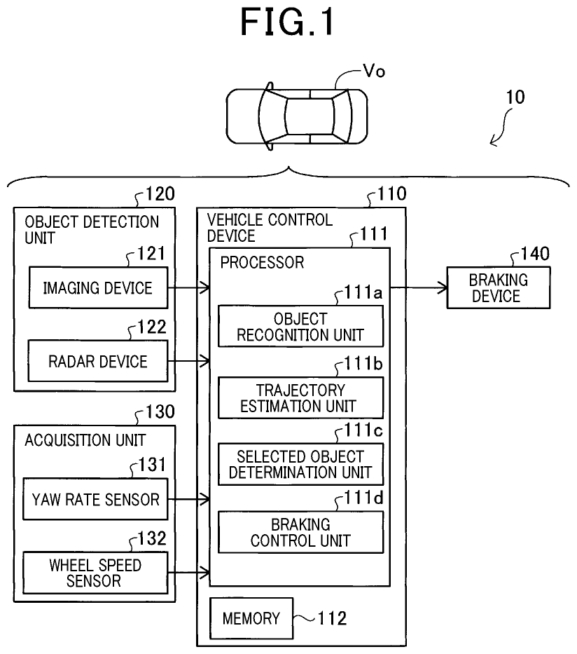

The vehicle control system 10 shown in FIG. 1 is mounted on a vehicle Vo. The vehicle control system 10 predicts a collision involving the vehicle Vo, thereby avoiding the collision or mitigating a damage due to the collision. Hereinafter, the vehicle Vo on which the vehicle control system 10 is mounted is also referred to as an own vehicle Vo. Furthermore, vehicles other than the own vehicle Vo are also referred to as other vehicles.

The vehicle control system 10 includes an object detection unit 120, an acquisition unit 130, a vehicle control device 110, and a braking device 140.

The object detection unit 120 acquires environmental information ahead of the own vehicle Vo. More specifically, the object detection unit 120 acquires information necessary to calculate the distance and relative speed to an object Ob existing ahead of the own vehicle Vo. Here, the term ‘object Ob’ refers to an object detected by the object detection unit 120. Furthermore, an object Ob detected by both the radar device 122 and the imaging device 121, which will be described below, is referred to as an object entity. Objects that can be detected as object Ob include vehicles Vo such as four-wheel or two-wheel vehicles. However, the object may also include humans. In the following description, for ease of understanding the technique, a four-wheel vehicle is exemplified as the object Ob.

The object detection unit 120 is provided with a radar device and an imaging device 121.

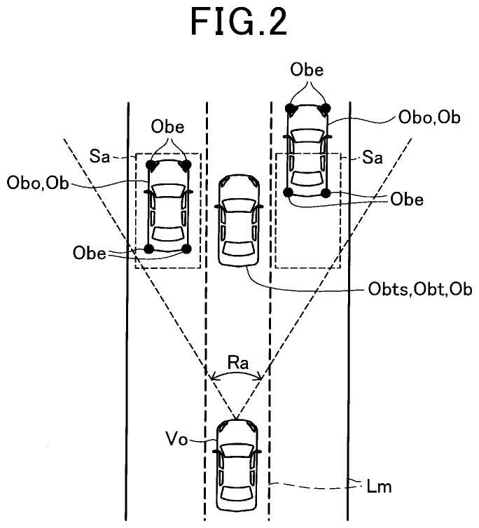

The radar device 122 acquires environmental information using, for example, millimeter waves. The radar device 122 is provided, for example, at a front bumper of the own vehicle Vo, thereby detecting a target object Ob existing within a predetermined angular range Ra ahead of the own vehicle Vo as shown in FIG. 2. That is, the environmental information acquired by the radar device 122 includes information such as a frequency difference, a time difference and a phase difference, based on changes between the transmitted millimeter waves and the waves reflected from the target object Ob.

The imaging device 121 is configured as a monocular CCD camera, for example. However, the imaging device 121 may be configured as a CMOS image sensor, a near-infrared camera, or the like. The imaging device 121 is provided, for example, at a predetermined height at the center in the vehicle width direction of the own vehicle Vo. By capturing images of a region extending forward of the own vehicle Vo within a predetermined angular range Ra, the imaging device 121 acquires, as environmental information, images of the area ahead of the own vehicle Vo.

Note that the imaging device 121 and the radar device 122 differ in the types and characteristics of objects which they can detect. Since the radar device 122 utilizes radio waves, the radar device 122 stably operates even in adverse weather conditions such as rain or fog. The imaging device 121 utilizes visible light, whereby imaging device 121 sometimes recognizes vehicles Vo and pedestrians in greater detail than the radar device 122. However, the imaging device 121 suffers from degraded image quality in dark environments or under backlighting conditions. Therefore, by combining the imaging device 121 and the radar device 122, the object detection unit 120 can improve the accuracy of object detection.

The braking device 140 shown in FIG. 1 decelerates or stops the traveling own vehicle Vo. Specifically, the braking device 140 is a disc brake. However, the brake 140 may be configured as a drum brake. The braking device 140 operates in response to driver operation or in accordance with a command from the vehicle control device 110. In the present specification, the braking device 140 is also referred to as a brake 140.

The acquisition unit 130 acquires information necessary for estimating a traveling path (trajectory) of the own vehicle Vo. The acquisition unit 130 includes a yaw-rate sensor 131 and a wheel speed sensor 132.

The yaw-rate sensor 131 is provided at a center part of the own vehicle Vo and acquires the angular rotational speed of the vehicle Vo.

The wheel speed sensor 132 acquires the rotational speed of each wheel of the own vehicle Vo. More specifically, the wheel speed sensor 132 is provided at the wheel portions of the own vehicle Vo and acquires the number of rotations of each wheel per unit time.

The vehicle control device 100 is a computer including a memory 112, an input/output interface (not shown), and a processor 111. The memory 112 and the input/output interface are connected to the processor 111 via a bus. For example, the functions provided by the vehicle control device 100 are accomplished by a driving control ECU (electronic control unit) for driving control of the own vehicle Vo.

The processor 111 is, for example, a CPU (central processing unit). The processor 111 executes programs stored in the memory 112, thereby accomplishing various functions. The memory 112 includes, for example, a RAM (random access memory) and a ROM (read-only memory). The memory 112 stores various programs and various data used for different processes executed by the vehicle control device 100. In the present embodiment, by executing the programs stored in the memory 112, the processor 111 functions as an object recognition unit 111a, a trajectory estimation unit 111b, a selected-object determination unit 111c, and a braking control unit 111d. The specific functions of the processor 111 will be described below.

A control method will be described in the followings.

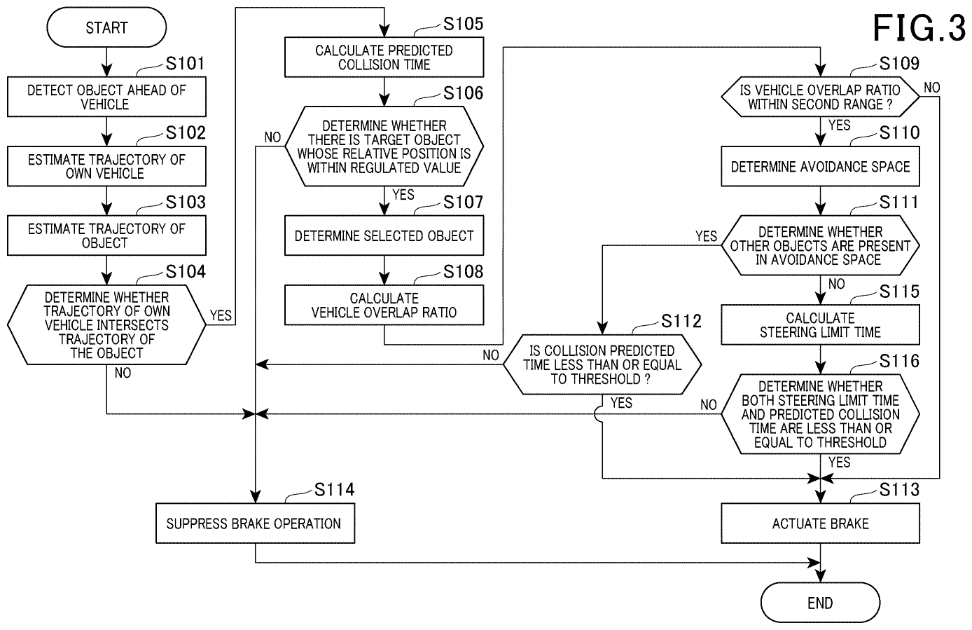

The control method of the vehicle control device 110 will be described with reference to FIG. 3. While the vehicle control device 110 is operating, the processor 111 repeatedly executes the following processes. That is, during the traveling of the own vehicle Vo, the following processes are repeatedly executed. In the following description, it is assumed, as in the traveling example of FIG. 2, that a plurality of other vehicles are present ahead of the own vehicle Vo.

At step S101 of FIG. 3, the processor 111 detects objects present ahead of the own vehicle Vo. More specifically, the processor 111 acquires environmental information ahead of the own vehicle Vo via the object detection unit 120. That is, the processor 111 acquires, using the radar device 122, the frequency difference, time difference, phase difference, and the like for objects Ob present within a predetermined angular range Ra. The processor 111 calculates, based on this information, the distance from the own vehicle Vo to the object Ob, the relative speed of the object Ob with respect to the own vehicle Vo, and the azimuth from the own vehicle Vo to the object Ob.

Furthermore, the processor 111 acquires an image capturing a predetermined angular range Ra ahead of the own vehicle Vo using the imaging device 121. The processor 111 recognizes, based on the acquired image, a plurality of objects Ob ahead of the own vehicle Vo. More specifically, the processor 111 recognizes the relative positions of the objects Ob with respect to the own vehicle Vo and their types by extracting feature points of the objects Ob. For feature point extraction, for example, Visual Odometry is used. For recognizing object Ob, semantic segmentation is used for example.

Next, the processor 111 fuses the objects Ob detected by the radar device 122 with the objects Ob detected by the imaging device 121. Specifically, the processor 111 maps the objects Ob detected by the radar device 122 and the objects Ob detected by the imaging device 121 onto the same coordinates. This process is also referred to as FSN (fusion). In FSN, the process using both the objects Ob detected by the radar device 122 and the objects Ob detected by the imaging device 121 is referred to as normal FSN. On the other hand, a process using either the objects Ob detected by the radar device 122 or the objects Ob detected by the imaging device 121 is referred to as abnormal FSN. The processor 111 defines those objects Ob for which both detections match as regular objects Ob in the following processes. Hereinafter, unless otherwise specified, objects Ob refer to those fused by normal FSN. In the processor 111, the functional unit that accomplishes step S101 is the object recognition unit 111a.

At step S102 of FIG. 3, the processor 111 estimates the trajectory of the own vehicle Vo. More specifically, the processor 111 first acquires the angular rotational velocity of the own vehicle Vo using the yaw-rate sensor 131. The processor 111 then acquires the wheel speeds of the own vehicle Vo using the wheel speed sensor 132 and calculates the travel speed of the own vehicle Vo based on the acquired wheel speeds.

Furthermore, the processor 111 calculates the curve radius of the own vehicle Vo based on the angular rotational speed and the travel speed. First, the processor 111 calculates the estimated trajectory of the own vehicle Vo if it travels along the calculated curve radius. Next, the processor 111 defines the size of the own vehicle, as viewed from above, as a rectangular region and calculates a presence area of the vehicle on the XY plane along the estimated trajectory. At this time, the processor 111 represents the transition of the presence area in a three-dimensional coordinate system that includes the time axis. That is, the processor 111 estimates the three-dimensional presence area of the own vehicle Vo by stacking the vehicle's presence area on the XY plane along the time axis. The presence area is also referred to as the ‘own vehicle solid model’. The curve radius of the own vehicle Vo may be calculated based on the steering angle acquired from a steering angle sensor provided in the own vehicle Vo.

At step S103 of FIG. 3, the processor 111 estimates the trajectory of the object Ob. More specifically, the processor 111 calculates the estimated trajectory of the object Ob based on changes in the position of the object Ob, which are determined from the position of the object Ob and the relative speed of the object Ob with respect to the own vehicle Vo. Further, the processor 111 estimates the three-dimensional presence area of the object Ob in a manner similar to a solid of the own vehicle. Additionally, the processor 111, using the object detection unit 120, recognizes four-wheeled vehicles among a plurality of objects Ob and can determine the four corners Obe of the four-wheeled vehicle, as shown in FIG. 2. As a result, the rectangular region of the object Ob is determined by detecting the four corners Obe which are the front right and left corners and the rear right and left corners of the object Ob.

However, for an object Ob traveling ahead of the own vehicle Vo, only some of the four corners Obe of the object may be detected. Specifically, there are cases where only the two rear corners Obe of the object Ob are detected, or where, in addition to those two corners Obe, only one of the front corners Obe is detected. In such cases, the processor 111 defines a rectangular region of the object Ob by estimating the remaining corners Obe as positions separated by a redetermined distance from the detected corners Obe. The spatial region occupied by the three-dimensional object Ob is also referred to as an object solid. As described above, the processor 111 estimates trajectories between the own vehicle Vo and a plurality of objects Ob. A functional unit that implements step S102 and step S103 in the processor 111 is a trajectory estimation unit 111b.

At step S104 of FIG. 3, the processor 111 determines whether the trajectory of the own vehicle Vo intersects the trajectory of the object Ob. That is, when the own vehicle solid intersects the object solid, the processor 111 advances the processing to step S105. When the own vehicle solid and the object solid do not intersect, the processor 111 advances the processing to step S114.

At step S105 of FIG. 3, the processor 111 calculates a predicted collision time (time to collision) with a target object Obt among a plurality of objects Ob, based on the distance to and the relative speed with the target object Obt. The target object Obt is an object Ob determined, based on the trajectory of the own vehicle Vo and the trajectory of the object Ob, such that a collision between the object Ob and the own vehicle Vo possibly occurs. More specifically, the processor 111 calculates, at predetermined time intervals, an overlapping region between an own vehicle solid and an object solid, based on the own vehicle solid and the object solid. Accordingly, the processor 111 calculates, as the predicted collision time, a time from the current time to a time point at which the overlapping region firstly occurs. When a plurality of objects Ob are present, a plurality of target objects Obt may exist. However, in the present embodiment, in order to facilitate understanding of the technique, the target object Obt is limited to an object Ob that is traveling on the same lane as the own vehicle Vo travels, as shown in FIG. 2.

At step S106 of FIG. 3, the processor 111 determines whether there exists a target object Obt whose relative position with respect to the own vehicle Vo is within a regulated value. More specifically, the processor 111 first determines a lateral position of the target object Obt based on environmental information. The lateral position of the target object Obt is a position of the object Ob in a vehicle-width direction orthogonal to the traveling direction of the own vehicle Vo. That is, as the lateral position of the target object Obt becomes smaller, the object Ob is closer to the traveling direction of the own vehicle Vo, and as the lateral position of the object Ob becomes larger, the object Ob is farther from the traveling direction of the own vehicle Vo. Accordingly, as the lateral position of the target object Obt becomes larger, the own vehicle Vo can more easily avoid the target object Obt.

The processor 111 compares the determined lateral position of the target object Obt with a predetermined lateral-position regulation value. The lateral-position regulation value serves as a criteria for determining whether the braking device 140 is to be activated based on the lateral position of the target object Obt. For example, the lateral-position regulation value is experimentally determined based on the vehicle width of the own vehicle Vo. For example, when the lateral position of the target object Obt is located outside the width range of the own vehicle Vo, the processor 111 determines that the relative position between the own vehicle Vo and the target object Obt is outside the regulation range. When the lateral position of the target object Obt is located within the width range of the own vehicle Vo, the processor 111 determines that the relative position between the own vehicle Vo and the target object Obt is within the regulation range.

When a target object Obt of which the relative position with respect to the own vehicle Vo is within the threshold range is present, the processor 111 advances the process to step S107. When there is no target object Obt of which the relative position with respect to the own vehicle Vo is within the threshold range, the processor 111 advances the process to step S114.

At step S107 of FIG. 3, the processor 111 determines, as a selected object Obts, the object Obt having the shortest predicted collision time among the target objects Obt of which the relative positions with respect to the own vehicle Vo have been determined to be within a regulation value. Hereinafter, an object Ob other than the selected object Obts may also be referred to as an other object Obo. Further, in the processor 111, a functional unit that implements steps S104 to S107 is a selected-object determination unit 111c.

At step S108 of FIG. 3, the processor 111 calculates a vehicle overlap ratio in the width direction between the own vehicle Vo and the selected object Obts. The vehicle overlap ratio represents the amount of overlap between the own vehicle Vo and the selected object Obts in the vehicle width direction. The processor 111 calculates the vehicle overlap ratio based on the relative positions of the own vehicle Vo and the selected object Obts in the width direction. Specifically, when the own vehicle Vo and the selected object Obts are viewed in the traveling direction of the own vehicle Vo, if the own vehicle Vo is entirely included within the selected object Obts, the vehicle overlap ratio is 100%. If the own vehicle Vo is partially included within the selected object Obts, the vehicle overlap ratio is calculated by taking an avoidance margin width into account. The avoidance margin width is calculated from the difference between the lateral position of the selected object Obts and the lateral position of the own vehicle Vo. That is, when the own vehicle Vo is partially included within the selected object Obts, the vehicle overlap ratio is calculated by subtracting the avoidance margin width from the vehicle width of the own vehicle Vo. When avoidance margin widths exist on both the left and right sides because the selected object Obts includes the own vehicle Vo, the vehicle overlap ratio is calculated using the larger one of the left and right avoidance margin widths of the own vehicle Vo.

At step S109 of FIG. 3, if the calculated vehicle overlap ratio is within a first range, the processor 111 advances the processing to step S113. For example, the first range is 51% to 100%. If the calculated vehicle overlap ratio is within a second range, the processor 111 advances the processing to step S110. For example, the second range is a range that includes an amount smaller than the amount of overlap of the first range. That is, the maximum value of the second range is smaller than the minimum value of the first range. For example, the second range is 0% to 50%.

In the case where the vehicle overlap ratio is included in the first range at step S109, at step S113, which will be described later, first braking control for actuating the brake 140 of the own vehicle Vo is executed. The condition under which the first braking control is executed is referred to as a high-overlap condition.

On the other hand, if, at step S109, the vehicle overlap ratio is included in the second range, second braking control including suppressing actuation of the brake 140 is executed. The condition under which the second braking control is executed is referred to as a low-overlap condition.

At step S110 of FIG. 3, the processor 111 determines an avoidance space Sa along a trajectory of a selected object Obts. More specifically, the processor 111 determines an avoidance space Sa in which the own vehicle Vo can travel so as to be adjacent to the selected object Obts, thereby determining a transition of the avoidance space Sa along the trajectory of the selected object Obts. Note that details of the avoidance space will be described below.

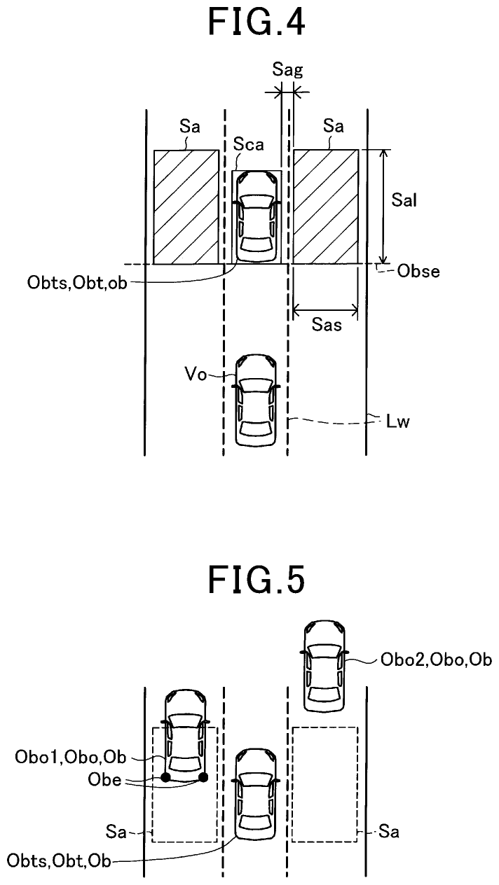

In FIG. 4, avoidance spaces Sa are shown in the lanes on both sides of the selected object Obts. However, for ease of understanding the technique, objects Ob other than the selected object Obts are not shown. The avoidance space Sa is set so as to be adjacent to the selected object Obts, allowing the own vehicle Vo to travel. Specifically, the avoidance space Sa has a rectangular shape based on the vehicle's overall length and the width of the lane. The long side Sal of the avoidance space Sa extends from the rear end Obse of the selected object Obts toward the front of the selected object Obts. The short side Sas of the avoidance space Sa extends perpendicular to the long side Sal. Here, the ‘vehicle's overall length’ refers to the general overall length of a typical vehicle. Therefore, for example, the long side Sal of the avoidance space Sa may be 5 m. The short side Sas of the avoidance space Sa may be 3 m based on a typical lane width. However, the long side Sal of the avoidance space Sa may also be 4 m or 6 m. The short side Sas of the avoidance space Sa may also be 3.5 m or 4 m.

Further, the avoidance space Sa is arranged so as to include lanes adjacent to the lane in which the selected object Obts is present. That is, the avoidance space Sa is set to extend across the road's white line Lw from the selected object Obts so as to be positioned on both sides of the selected object Obts. For example, the avoidance space Sa is set at a position spaced by 0.5 m, denoted as Sag, from the lateral edge of the selected object Obts. However, the spacing Sag may also be 1 m, 1.5 m, or the like.

The processor 111 determines the avoidance space Sa along the trajectory of the selected object Obts. That is, processor 111 estimates the three-dimensional transition of the avoidance space Sa by stacking the avoidance space Sa on the XY plane along the time axis, in the same manner as the trajectory of the own vehicle Vo and the trajectory of the object Ob.

At step S111 of FIG. 3, processor 111 determines, based on the trajectories of other objects Obo among the plurality of objects Ob excluding the selected object Obts, and based on the result of the transition of the avoidance space Sa, whether other objects Obo are present in the avoidance space Sa. More specifically, processor 111 determines whether an object solid and the evolution result of the avoidance space Sa intersect with each other. Accordingly, even when no other object Obo is present in the current avoidance space Sa, processor 111 performs the determination while taking into consideration the possibility that another object Obo may be present in the avoidance space Sa in the future. The criteria for determining whether another object Obo is present in the avoidance space Sa will be described with reference to FIG. 2.

When none of the four corners Obe of a four-wheeled vehicle included in another object Obo are present within the avoidance space Sa, the processor 111 determines that no other object Obo exists in the avoidance space Sa. On the other hand, when at least one of the four corners Obe of another object Obo is present within the avoidance space Sa, the processor 111 determines that another object Obo exists in the avoidance space Sa. For example, as shown in FIG. 2, when all four corners Obe of another object Obo are present within the avoidance space Sa, such as an object located to the left of the selected object Obts, the processor 111 determines that another object Obo exists in the avoidance space Sa. Furthermore, even when only the two rear corners Obe of another object Obo are present within the avoidance space Sa, such as an object located to the right of the selected object Obts, the processor 111 still determines that another object Obo exists in the avoidance space Sa. With this configuration, the vehicle control device 110 of the present embodiment is able to reduce the risk of the own vehicle Vo colliding with another object Obo, compared with a configuration in which the entire of another object Obo must be contained within the avoidance space Sa.

When another object Obo exists in the avoidance space Sa, the processor 111 advances the processing to step S112. When no other object Obo exists in the avoidance space Sa, the processor 111 advances the processing to step S115.

At step S112 of FIG. 3, the processor 111 determines whether the predicted collision time is less than or equal to a threshold. The threshold is determined based on the braking time required to stop the own vehicle Vo, and is also referred to as a reference time. When the predicted collision time is less than or equal to the threshold, the own vehicle Vo is unlikely to avoid a collision within the predicted collision time using the brake 140. When the predicted collision time exceeds the threshold, the own vehicle Vo is likely to avoid a collision using brake 140 before the predicted collision time. Accordingly, when the predicted collision time is less than or equal to the threshold, the processor 111 advances the processing to step S113. When the predicted collision time exceeds the threshold, the processor 111 advances the processing to step S114.

At step S113 of FIG. 3, the processor 111 operates the brake 140. That is, the processor 111 stops or decelerates the own vehicle Vo, thereby avoiding a collision or reducing damage caused by a collision.

At step S114 of FIG. 3, the processor 111 suppresses operation of the brake 140. For example, when operation of the brake 140 has not yet been performed, the processor 111 proceeds with the processing without actuating the brake 140. However, when operation of the brake 140 has already been performed by the vehicle control device 110, the processor 111 cancels the operation of the brake 140. Note that a case in which step S114 is executed while operation of the brake 140 has already been performed includes, for example, a case where another object Obo has changed such that another object Obo no longer exists in the avoidance space Sa.

At step S115 of FIG. 3, the processor 111 calculates a steering limit time during which the own vehicle Vo is able to avoid a collision with the selected object Obts using a steering operation, based on a lateral relative position and a relative speed between the own vehicle Vo and the selected object Obts at the time of estimating the trajectory of the own vehicle Vo and the trajectories of a plurality of objects Ob. The steering limit time varies depending on a vehicle overlap ratio. Accordingly, the steering limit time is calculated, for example, based on a vehicle overlap ratio between the own vehicle Vo and another vehicle, and a relative distance.

At step S116 of FIG. 3, the processor 111 determines whether both a steering limit time and a predicted collision time are less than or equal to a threshold. The threshold is the same as that used in step S112. That is, when both the steering limit time and the predicted collision time are less than or equal to the threshold, the own vehicle Vo is unlikely to avoid a collision with a steering operation, and immediate braking of the own vehicle Vo is required. Accordingly, since operation of the brake 140 is necessary, the processor 111 advances the processing to step S113. When at least one of the steering limit time and the predicted collision time is less than or equal to the threshold, the own vehicle Vo is likely to avoid a collision using the braking by the brake 140 or a steering operation. That is, since operation of the brake 140 can be suppressed, the processor 111 advances the processing to step S114. Note that, in the processor 111, a functional unit that implements steps S108 to S114 is a braking control unit 111d.

As described above, the vehicle control device 110 predicts a collision of the own vehicle Vo and, in accordance with the likelihood of the collision, actuates and suppresses operation of the brake 140. Specifically, when the conditions that another object Obo is present in the avoidance space Sa and that the predicted collision time is shorter than a reference time are satisfied, the vehicle control device 110 actuates the brake 140. These conditions are referred to as braking conditions. When the conditions that no other object Obo is present in the avoidance space Sa and that at least one of the predicted collision time and the steering limit time is longer than the reference time are satisfied, the vehicle control device 110 suppresses actuation of the brake 140. These conditions are referred to as avoidance conditions.

In this mode, the second braking control is executed when the lateral overlap between the own vehicle Vo and the selected object Obts is relatively small. More specifically, the second braking control is executed when the probability that the own vehicle Vo is able to avoid the selected object Obts is high. The second braking control actuates the brake 140 when the braking conditions, including the condition that another object Obo exists in the avoidance space Sa, are satisfied. When the own vehicle Vo avoids the selected object Obts, it is highly likely to pass beside the selected object Obts. However, if another object Obo exists in the avoidance space Sa adjacent to the selected object Obts, the own vehicle Vo may collide with the other object Obo even if it avoids the selected object Obts. That is, according to the present embodiment, the vehicle control device 110 actuates the brake 140 when a probability that the own vehicle Vo is able to avoid the selected object Obts is high and there is an obstacle in the avoidance space Sa. In other words, even when the driver is highly likely to be able to avoid the selected object Obts by operating the own vehicle Vo, if it is difficult to avoid the obstacle at the avoidance destination, the operation of the brake 140 is not suppressed. Hence, the vehicle control device 110 of the present embodiment is less likely to cause the driver to feel a sense of inconsistency or discomfort due to a difference between the vehicle's behavior and the driver's judgment.

Furthermore, the braking condition includes that a predicted collision time is shorter than a reference time. With such a configuration, the vehicle control device 110 of the present embodiment actuates the brake 140 when another object Obo exists in the avoidance space Sa and the predicted collision time is shorter than the reference time. That is, the brake 140 is actuated when the own vehicle Vo cannot move into the avoidance space Sa and there is a high possibility of collision with the selected object Obts. Therefore, compared with a case where the brake 140 is actuated solely on the condition that another object Obo exists in the avoidance space Sa, the vehicle control device 110 of the present embodiment is able to operate the brake 140 in situations where collision avoidance is difficult, while not hindering the driver's operation.

Moreover, the avoidance condition includes that at least one of a predicted collision time and a steering limit time is longer than a reference time. With such a configuration, the vehicle control device 110 of the present embodiment suppresses operation of the brake 140 when no other object Obo exists in the avoidance space Sa and at least one of the predicted collision time and the steering limit time is longer than the reference time. That is, after determining that there is sufficient time for the own vehicle Vo to avoid the selected object Obts, or that braking of the own vehicle Vo can be completed in time before a collision between the own vehicle Vo and the selected object Obts occurs, operation of the brake 140 is suppressed. Therefore, compared with a case where the operation of the brake 140 is suppressed solely on the condition that no other object Obo exists in the avoidance space Sa, the vehicle control device 110 of the present embodiment is able to suppress operation of the brake 140 at a more appropriate timing.

Furthermore, the avoidance space Sa has a rectangular shape based on the overall length of the own vehicle Vo and the width of the lane, and includes a lane adjacent to the lane in which the selected object Obts is present. The own vehicle Vo traveling on a road is highly likely to change lanes and travel on a lane adjacent to the selected object Obts. With such a configuration, the likelihood that the own vehicle Vo will travel through the avoidance space Sa is increased. Therefore, the vehicle control apparatus 110 according to the present embodiment is able to accurately determine the presence or absence of another object Obo that would become an obstacle in the avoidance destination of the own vehicle Vo.

Furthermore, the vehicle control apparatus 110 according to the present embodiment determines that another object Obo is present in the avoidance space Sa even when a part of another object Obo is included in the avoidance space Sa. With this configuration, compared with a configuration in which it is necessary for the entirety of another object Obo to be included in the avoidance space Sa in order to determine that another object Obo is present in the avoidance space Sa, the vehicle control apparatus 110 according to the present embodiment can reduce the risk of the vehicle Vo colliding with another object Obo.

### Second Embodiment

In the above-described embodiment, in order for the avoidance space Sa determined at step S110 to be finally determined as an available avoidance space Sa, it is required that no other object Obo be present in the avoidance space Sa. This condition may be used to finally determine an available avoidance space Sa by a method that is stricter than that of the first embodiment.

The second embodiment will be described with reference to the example shown in FIG. 5. In FIG. 5, a first object Obo1 as another object Obo is present in the avoidance space Sa on the left side of the selected object Obts. However, no object Ob is present in the avoidance space Sa on the right side of the selected object Obts. Nevertheless, a second object Obo2 as another object Obo is present near the avoidance space Sa on the right side of the selected object Obts. Note that the system configurations of the first embodiment and the second embodiment are the same. Further, unless otherwise specified, the control processing of the first embodiment and the second embodiment is the same.

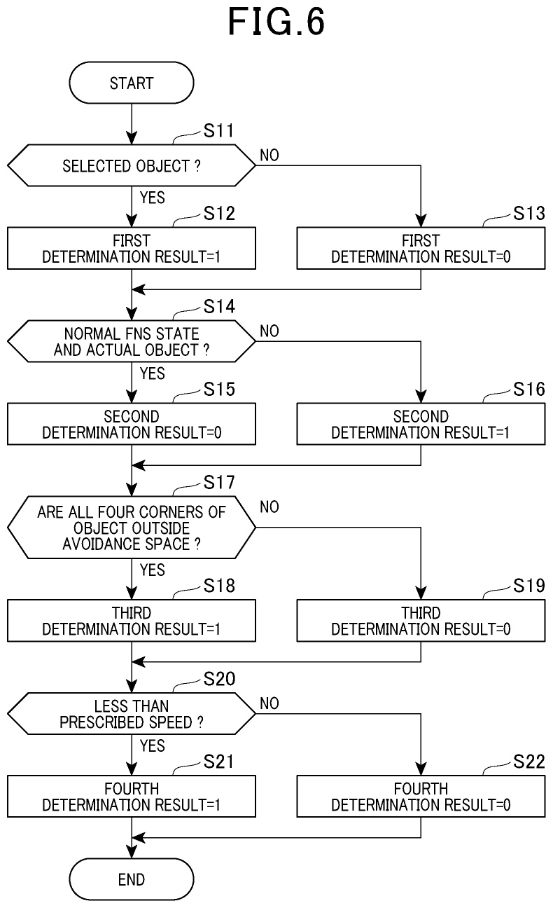

In the second embodiment, the determinations shown in FIGS. 6 to 8 are performed. Note that these determinations are executed, for example, at step S111 of FIG. 3. Furthermore, when the processor 111 finally determines that an available avoidance space Sa exists, the processor 111 advances the processing to step S115 shown in FIG. 3. When the processor 111 determines that no available avoidance space Sa exists, the processor 111 advances the processing to step S112 shown in FIG. 3. The determinations shown in FIGS. 6 to 8 are performed for all of a plurality of objects Ob, including the selected object Obts.

As shown in FIG. 6, in order to determine an available avoidance space Sa, the following determinations are first performed for each object Ob. The first determination is whether the object is the selected object Obts. The second determination is whether the normal FSN state is in the normal FSN condition and whether the selected object Obts is an actual object. The third determination is whether all four corners Obe of the object Ob are outside the avoidance space Sa. The fourth determination is whether the relative velocity difference Vd between another object Obo and the selected object Obts is less than a predetermined velocity. The processor 111 first determines the truth or false of these determinations. In the following description, ‘1’ indicates true and ‘0’indicates false.

In step S11 of FIG. 6, the processor 111 performs the first determination. Specifically, when the object to be determined is the selected object Obts, the processor 111 advances the processing to step S12, thereby determining the first determination result as ‘1’. When the object to be determined is not the selected object Obts, the processor 111 advances the processing to step S13, thereby determining the first determination result as ‘0’. The first determination is performed to confirm that the selected object Obts reliably exists.

In step S14 of FIG. 6, the processor 111 performs the second determination. Specifically, when the FSN state is a normal FSN state and the selected object Obts is an actual object, the processor 111 advances the processing to step S15, thereby determining the second determination result as ‘0’. When at least one of the condition that the FSN state is a normal FSN state and the condition that the selected object Obts is an actual object is not satisfied, the processor 111 advances the processing to step S16, thereby determining the second determination result as ‘1’.

A case where the condition that the FSN state is a normal FSN state is not satisfied specifically refers to a case where the FSN state is a non-normal FSN state. That is, the object Ob is detected by only one of a radar device 122 and an imaging device 121. A case where the condition that the object Ob is an actual object is not satisfied refers to a case where the object Ob is detected by both the radar device 122 and the imaging device 121, but an object Ob detected by either one of the devices is also treated as a regular object Ob.

The imaging device 121 and the radar device 122 differ in the types and characteristics of objects that they can detect. For this reason, object detection accuracy is higher when the FSN state is a normal FSN state and the selected object Obts is an actual object than when the FSN state is a non-normal FSN state or the selected object Obts is not an actual object. Accordingly, the second determination is performed to determine whether the object is correctly detected.

In step S17 of FIG. 6, the processor 111 performs the third determination. Specifically, when all four corners Obe of another object Obo are located outside the avoidance space Sa, the processor 111 advances the processing to step S18, thereby determining the third determination result as ‘1’. When at least one of the four corners Obe of another object Obo is located within the avoidance space Sa, the processor 111 advances the processing to step S19, thereby determining the third determination result as ‘0’. The specific determination method is as described above with reference to step S111. The third determination is performed to reduce a risk of the own vehicle Vo colliding with another object Ob, as compared with an aspect in which the entirety of another object Obo is required to be included in the avoidance space Sa.

In step S20 of FIG. 6, the processor 111 performs the fourth determination. Specifically, when a relative speed difference between another object Obo and the selected object Obts is greater than or equal to a prescribed speed, the processor 111 advances the processing to step S21, thereby determining the fourth determination result as ‘1’. When the relative speed difference Vd between another object Obo and the selected object Obts is less than the prescribed speed, the processor 111 advances the processing to step S22, thereby determining the fourth determination result as ‘0’. When a longitudinal speed of another object Obo is Vobo, a longitudinal speed of the own vehicle Vo is Vvo, and a longitudinal speed of the selected object Obts is Vobts, the relative speed difference Vd between another object Obo and the selected object Obts is obtained by:
Vd=|(Vobo−Vvo)−(Vobts−Vvo)|=|Vobo−Vobts|. Note that the prescribed speed is set experimentally.

The fourth determination is performed to take into consideration whether another object Obo will be outside the avoidance space Sa in the future, even when another object Obo exists in the avoidance space Sa at the time of determination. The fourth determination is performed, whereby it is possible to make a more accurate determination than in a configuration in which whether another object Obo will exist in the avoidance space Sa in the future is determined solely based on an estimated trajectory of the object Ob.

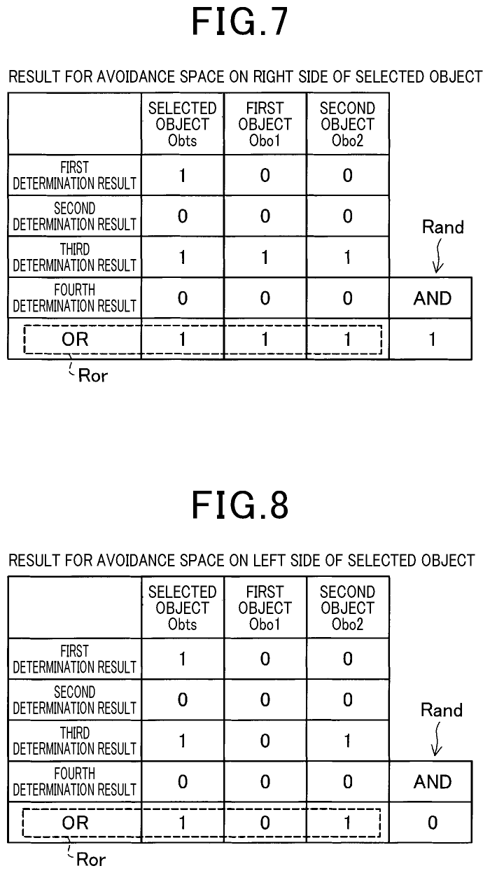

In the examples of determinations shown in FIGS. 7 and 8, for the sake of easier understanding of the technique, it is assumed that the relative speed difference Vd is greater than the prescribed speed and that the conditions of a normal FSN state and an actual object are satisfied. That is, it is assumed that the results of the second and fourth determinations are ‘0’.

In FIG. 7, the determination result Rand indicating whether an available avoidance space Sa exists to the right of the selected object Obts in the example of FIG. 5 is shown. In FIG. 7, the results of the first to fourth determinations from FIG. 6 are illustrated for each object Ob. The fifth determination result Ror represents the logical OR of the first to fourth determination results for each object Ob. For the avoidance space Sa to the right of the objects Ob and the selected object Obts in FIG. 5, when the first to fourth determination results are obtained, the third determination result for all objects Ob becomes ‘1’, so the fifth determination result Ror for all objects Ob is ‘1’. The final determination result Rand in FIG. 7 is the logical AND of the fifth determination results Ror. That is, regarding the available avoidance space Sa to the right of the selected object Obts, the final determination result Rand is ‘1’. A final determination result Rand of ‘1’ indicates that an available avoidance space Sa exists, whereas ‘0’ indicates that no available avoidance space Sa exists. In other words, the processor 111 determines that an available avoidance space Sa exists to the right of the selected object Obts.

In FIG. 8, the determination result Rand indicating whether an available avoidance space Sa exists to the left of the selected object Obts in the example of FIG. 5 is shown. For the avoidance space Sa to the left of the objects Ob and the selected object Obts in FIG. 5, when the first to fourth determination results are obtained, all determination results for the first object Obo1 become ‘0,’ so the fifth determination result Ror is also determined to be ‘1’. Accordingly, the final determination result Rand is ‘0.’ Therefore, the processor 111 determines that no available avoidance space Sa exists to the left of the selected object Obts.

With such an above-described aspect, the vehicle control device 110 of the present embodiment is able to determine the presence or absence of an available avoidance space Sa more accurately, as compared with a configuration in which an available avoidance space Sa is determined solely on the condition that a part of another object Ob is included in the avoidance space Sa.

### Other Embodiments

(C1) In the above-described embodiments, the braking condition does not need to include that the predicted collision time is shorter than a reference time. The braking condition must include the presence of another object Obo in the avoidance space Sa.
(C2) In the above-described embodiments, the avoidance condition does not need to include that at least one of a predicted collision time and a steering limit time is longer than a reference time. The avoidance condition is required to include that no other object Obo is present in the avoidance space Sa.
(C3) In the above-described embodiments, the avoidance space Sa has a rectangular shape based on an overall length of the own vehicle Vo and a width of a lane, and includes a lane adjacent to the lane in which the selected object Obts is present. However, the avoidance space Sa only needs to be set so as to be adjacent to the selected object Obts and to allow the own vehicle Vo to travel therein. For example, the shape of the avoidance space Sa may be a quadrilateral. In the above-described embodiments, the avoidance space Sa does not include a lane marking Lw, however, the avoidance space Sa may be set to include, together with the lane marking Lw, a lane adjacent to the lane in which the selected object Obts is present.
(C4) In the above-described embodiments, when even a part of another object Obo is included in the avoidance space Sa, it is determined that another object Obo is present in the avoidance space Sa. However, in order to determine that another object Obo is present in the avoidance space Sa, it may be required that the entirety of the other object Obo be included in the avoidance space Sa.
(C5) In the above-described embodiments, an example is given in which the first range is 51 to 100% and the second range is 0 to 50%. However, the combination of the first range and the second range may be another combination of ranges. For example, the first range may be 71 to 100% and the second range may be 0 to 70%. Furthermore, the range of 0 to 100% of the vehicle overlap ratio may be combined with other ranges. That is, the first range may be 51 to 100%, the second range may be 11 to 50%, and a third range as another range may be 0 to 10%.
(C6) In the above-described embodiments, the processor 111 determines whether the predicted collision time is equal to a threshold. However, the processor 111 may determine whether the predicted collision time is less than the threshold.
(C7) In the above-described embodiment, suppression of operation of the brake 140 in step S114 refers to an operation of the brake 140 is not performed. However, suppression of operation of the brake 140 in step S114 may be a process for applying a braking force smaller than that in step S113.
(C8) In the above-described embodiments, in step S106 of FIG. 3, the processor 111 determines whether a target object Obt of which the relative position with respect to the own vehicle Vo is within a regulation value exists. However, the processor 111 does not need to perform this step. That is, step S107 may be performed next after step S105.
(C9) The control unit described in the present disclosure and the methods thereof may be implemented by a dedicated computer provided by configuring a processor and a memory programmed to execute one or more functions embodied by a computer program. Alternatively, the control unit described in the present disclosure and the methods thereof may be implemented by a dedicated computer provided by configuring a processor with one or more dedicated hardware logic circuits. Alternatively, the control unit described in the present disclosure and the methods thereof may be implemented by one or more dedicated computers provided by a combination of a processor and a memory programmed to execute one or more functions and a processor configured by one or more hardware logic circuits. Further, the computer program may be stored as instructions executed by a computer in a computer-readable non-transitory tangible recording medium.

The present disclosure is not limited to the above-described embodiments and modifications, and may be implemented in various manners within a range that does not depart from the spirit of the disclosure. For example, the technical features in each form described in the summary part and the technical features in the embodiments or modifications may be appropriately replaced or combined to solve a part or all of the above-described problems, or to achieve a part or all of the above-described effects. Further, if a technical feature is not described as essential in the present specification, it may be appropriately deleted.

Other configurations will be described as follows.

### Configuration 1

A vehicle control apparatus mounted for a vehicle provided with an object detection unit acquiring environmental information ahead of the vehicle, the vehicle control apparatus comprising:
an object recognition unit that recognizes a plurality of objects ahead of the vehicle based on the environmental information, and calculates distances and relative speeds between respective objects and the vehicle;
a trajectory estimation unit that estimates a trajectory of the vehicle and trajectories of the plurality of objects;
a selected-object determination unit that determines a selected object selected from among target objects by calculating a predicted collision time between the vehicle and each target object, the target objects being determined to possibly collide with the vehicle based on the trajectory of the vehicle and the trajectories of the plurality of objects, the selected object having the shortest predicted collision time among those in the target objects; and
a braking control unit that executes a first braking control to activate a brake of the vehicle when a high-overlap condition is satisfied and executes a second braking control including suppressing actuation of the brake when a low-overlap condition is satisfied, the high-overlap condition being that an amount of overlapping between the vehicle and the selected object in a width direction, with respect to the trajectory of the vehicle and trajectories of the plurality of objects, is within a first range, and the low-overlap condition being that an amount of overlapping between the vehicle and the selected object in a width direction, with respect to the trajectory of the vehicle and trajectories of the plurality of objects, is within a second range smaller than the first range,
   wherein
the second braking control is configured to: i) determine an avoidance space where the vehicle is capable traveling adjacently to the selected object, thereby determining a transition of the avoidance space along the trajectory of the selected object, ii) determine whether another object exists in the avoidance space based on a trajectory of another object other than the selected object among trajectories of the plurality of objects and a result of transition of the avoidance space and iii) actuate the brake when a braking condition including that another object exists in the avoidance space is satisfied and iv) suppress actuation of the brake when an avoidance condition including that another object does not exist in the avoidance space is satisfied.

### Configuration 2

The vehicle control apparatus according to configuration 1,
wherein
   the braking condition further includes that the predicted collision time is shorter than a reference time determined based on a braking time required for stopping the vehicle.

### Configuration 3

The vehicle control apparatus according to configuration 2,
wherein
   the braking control unit is configured to, when determining whether the braking condition is satisfied, calculate a steering limit time during which the vehicle is able to avoid a collision with the selected object using a steering operation, based on a lateral relative position in the width direction and a relative speed between the vehicle and the selected object at the time of estimating the trajectory of the vehicle and the trajectories of a plurality of objects; and
   the avoidance condition further includes that at least one of the predicted collision time and the steering limit time is longer than the reference time are satisfied.

### Configuration 4

The vehicle control apparatus according to configuration 3,
wherein
   the second braking control is configured to determine a location of the avoidance space such that the avoidance space has a rectangular shape and includes a lane adjacent to a lane in which the selected object exists.

### Configuration 5

The vehicle control apparatus according to configuration 4,
wherein
   the object recognition unit is configured to recognize a four-wheel vehicle included in the plurality of objects and to determine four corners of the recognized four-wheel vehicle; and
   the second braking control is configured to determine that other object does not exist in the avoidance space when none of the four corners of each four-wheel vehicle included in other objects, and determine that other object exists in the avoidance space when any one of the four corners is included in the avoidance space.

### Conclusion

The present disclosure is embodied in the following manners.

One aspect of the present disclosure is a vehicle control apparatus mounted for a vehicle provided with an object detection unit acquiring environmental information ahead of the vehicle. The vehicle control apparatus includes:
an object recognition unit that recognizes a plurality of objects ahead of the vehicle based on the environmental information, and calculates distances and relative speeds between respective objects and the vehicle;
a trajectory estimation unit that estimates a trajectory of the vehicle and trajectories of the plurality of objects;
a selected-object determination unit that determines a selected object selected from among target objects by calculating a predicted collision time between the vehicle and each target object, the target objects being determined to possibly collide with the vehicle based on the trajectory of the vehicle and the trajectories of the plurality of objects, the selected object having the shortest predicted collision time among those in the target objects; and
a braking control unit that executes a first braking control to activate a brake of the vehicle when a high-overlap condition is satisfied and executes a second braking control including suppressing actuation of the brake when a low-overlap condition is satisfied, the high-overlap condition being that an amount of overlapping between the vehicle and the selected object in a width direction, with respect to the trajectory of the vehicle and trajectories of the plurality of objects, is within a first range, and the low-overlap condition being that an amount of overlapping between the vehicle and the selected object in a width direction, with respect to the trajectory of the vehicle and trajectories of the plurality of objects, is within a second range smaller than the first range,
   wherein
the second braking control is configured to: i) determine an avoidance space where the vehicle is capable traveling adjacently to the selected object, thereby determining a transition of the avoidance space along the trajectory of the selected object, ii) determine whether another object exists in the avoidance space based on a trajectory of another object other than the selected object among trajectories of the plurality of objects and a result of transition of the avoidance space and iii) actuate the brake when a braking condition including that another object exists in the avoidance space is satisfied and iv) suppress actuation of the brake when an avoidance condition including that another object does not exist in the avoidance space is satisfied.

According to the above-described aspect, in the case where it is difficult to avoid an obstacle in the avoidance direction even when a selected object is likely to be avoided by operating the vehicle with the driver, activation of the braking is not suppressed. Hence, the vehicle control apparatus of the present embodiment is less likely to cause the driver to feel a sense of inconsistency or discomfort due to a difference between the vehicle's behavior and the driver's judgment.

What is claimed is:

1. A vehicle control apparatus for a vehicle provided with an object detection unit acquiring environmental information ahead of the vehicle, the vehicle control apparatus comprising:
an object recognition unit that recognizes a plurality of objects ahead of the vehicle based on the environmental information, and calculates distances and relative speeds between respective objects and the vehicle;
a trajectory estimation unit that estimates a trajectory of the vehicle and trajectories of the plurality of objects;
a selected-object determination unit that determines a selected object selected from among target objects by calculating a predicted collision time between the vehicle and each target object, the target objects being determined to possibly collide with the vehicle based on the trajectory of the vehicle and the trajectories of the plurality of objects, the selected object having the shortest predicted collision time among those in the target objects; and
a braking control unit that executes a first braking control to activate a brake of the vehicle when a high-overlap condition is satisfied and executes a second braking control including suppressing actuation of the brake when a low-overlap condition is satisfied, the high-overlap condition being that an amount of overlapping between the vehicle and the selected object in a width direction, with respect to the trajectory of the vehicle and trajectories of the plurality of objects, is within a first range, and the low-overlap condition being that an amount of overlapping between the vehicle and the selected object in a width direction, with respect to the trajectory of the vehicle and trajectories of the plurality of objects, is within a second range smaller than the first range,
wherein
the second braking control is configured to: i) determine an avoidance space where the vehicle is capable traveling adjacently to the selected object, thereby determining a transition of the avoidance space along the trajectory of the selected object, ii) determine whether another object exists in the avoidance space based on a trajectory of another object other than the selected object among trajectories of the plurality of objects and a result of transition of the avoidance space and iii) actuate the brake when a braking condition including that another object exists in the avoidance space is satisfied and iv) suppress actuation of the brake when an avoidance condition including that another object does not exist in the avoidance space is satisfied.

2. The vehicle control apparatus according to claim 1,
wherein
the braking condition further includes that the predicted collision time is shorter than a reference time determined based on a braking time required for stopping the vehicle.

3. The vehicle control apparatus according to claim 2,
wherein
the braking control unit is configured to, when determining whether the braking condition is satisfied, calculate a steering limit time during which the vehicle is able to avoid a collision with the selected object using a steering operation, based on a lateral relative position in the width direction and a relative speed between the vehicle and the selected object at the time of estimating the trajectory of the vehicle and the trajectories of a plurality of objects; and
the avoidance condition further includes that at least one of the predicted collision time and the steering limit time is longer than the reference time are satisfied.

4. The vehicle control apparatus according to claim 3,
wherein
the second braking control is configured to determine a location of the avoidance space such that the avoidance space has a rectangular shape and includes a lane adjacent to a lane in which the selected object exists.

5. The vehicle control apparatus according to claim 4,
wherein
the object recognition unit is configured to recognize a four-wheel vehicle included in the plurality of objects and to determine four corners of the recognized four-wheel vehicle; and
the second braking control is configured to determine that other object does not exist in the avoidance space when none of the four corners of each four-wheel vehicle included in other objects, and determine that other object exists in the avoidance space when any one of the four corners is included in the avoidance space.
